(19) United States
(12) Patent Application Publication
(10) Pub. No.: US 2005/0236795 A1
(43) Pub. Date: Oct. 27, 2005

(54) Rear vehicle axle

(76) Inventor: Thomas Schreiber, Weinstadt (DE)

Correspondence Address: KLAUS J. BACH, 4407 TWIN OAKS DRIVE, MURRYSVILLE, PA, 15668, US

(21) Appl. No.: 11/105,599

(22) Filed: Apr. 14, 2005

(30) Foreign Application Priority Data
Apr. 23, 2004 (DE) 102004020050.5

(51) Int. Cl. B60G 9/02

(52) U.S. Cl. 280/124.116

(57) ABSTRACT

In a rear vehicle axle comprising an axle body for supporting a vehicle body, a transverse force transmitting unit for transferring vehicle body side forces to the axle body and a longitudinal force support arrangement for transferring longitudinal forces between the vehicle body and the axle body, the longitudinal force transmitting arrangement has means which are movable so as to be displaced when the axle body is subjected to side forces while the vehicle is driving through a curve for providing side force steering motions to the vehicle axle.

### BACKGROUND OF THE INVENTION

The invention relates to a rear vehicle axle including an axle body, a side force support structure for accommodating side forces and a longitudinal force support structure for accomodating forces in the travel direction of the vehicle.

U.S. Pat. No. 3,931,863 discloses such a rear vehicle axis with a rigid axle body, a lateral force support structure for accommodating side force and a longitudinal force support structure for accommodating longitudinal forces.

For noise reduction, an additional weight is provided in the area where the transverse guide arm of the lateral force support structure is connected to the rigid vehicle body in order to attenuate vibrations of the axle housing.

It is the main object of the present invention to provide such a rear vehicle axle with improved dynamic operating properties whereby the vehicle operating comfort is improved.

### SUMMARY OF THE INVENTION

In a rear vehicle axle comprising an axle body for supporting a vehicle body, a transverse force transmitting unit for transferring vehicle body side forces to the axle body and a longitudinal force support arrangement for transferring longitudinal forces between the vehicle body and the axle body, the longitudinal force transmitting arrangement has means which are movable so as to be displaced when the axle body is subjected to side forces while the vehicle is driving through a curve for providing side force steering motions to the vehicle axle.

Advantageously a side force steer component may be increased and a tilt steer component may be reduced whereby an improved driving dynamic can be achieved. Furthermore, by the means for moving the longitudinal force transmission unit, the transmission of vibrations of the rear axle to the vehicle body and noises caused thereby can be reduced and the vehicle operating comfort can be improved.

Tilt-steering is to be understood in this connection to mean a change of a trail angle of the rear axle as a result of tilting of a vehicle body supported by the rear axle. The axle is preferably a rigid axle which is particularly advantageous in connection with transport vehicles such as trucks or vans. However, the axle body may be movable in various ways as it may be considered to be reasonable by a person skilled in the art; it may be particularly elastically deformable for example by torsion. The side force support unit and the longitudinal force support unit may be formed by simple guide rod arrangements such as transverse control arms or longitudinal control arms or other components which appear reasonable to a person skilled in the art such as side force support units including a so-called Watt linkage or a Panhard rod.

The movable arrangement of the longitudinal force support unit can be provided by various measures. For example, the longitudinal support arm may consist of two parts which are longitudinally movable relative to each other or a longitudinal support arm which is elastically deformable in the longitudinal direction, etc. However, if the longitudinal force support unit includes a spring unit for the movable support of the longitudinal force support unit in the longitudinal direction, simple design features and controlled movement and an advantageous rigidity can be achieved.

In another embodiment of the invention, the spring unit has, in the longitudinal direction, at least one sudden impedance change such that, under extreme conditions such as during emergency braking, a particularly high rigidity is achieved.

If a sudden impedance change is achieved by at least one stop, the arrangement can be provided in a particularly inexpensive way, but other solutions are possible such as the provision of special spring elements.

Furthermore, it is proposed that the stop is provided by a spring or resilient element in order to achieve damped engagement and a long life of the stop.

In another particular embodiment, the spring unit should have, in the longitudinal direction, a spring constant of 750 N/mm to 1050 N/mm, particularly for trucks of 2 tons to 5 tons, such that an advantageously increased rigidity, particularly transverse rigidity can be achieved with a desired side force steering level.

The longitudinal force support unit is advantageously movable in longitudinal direction over a distance of at least 1 mm, preferably however, starting from an equilibrium position, over a distance of at least ±2 mm or ±3 mm so that, with simple design features, a side force steering component of the desired level can be achieved and the tilt steer part can be reduced in the desired way. Preferably, the tilt steer part is less than 0.3 degree trail angle in either direction and preferably essentially zero.

If the side force support unit includes a transverse force support structure which, at least in transverse direction has a larger spring constant than in the longitudinal direction, a high transverse rigidity with a still advantageous uncoupling of vibrations can be achieved. The spring stiffness of the side force support structure in the transverse direction is preferably at least twice the spring stiffness of the spring unit in the longitudinal direction.

It is furthermore proposed that the rear axle includes a spring unit with a progressive spring characteristic in vertical direction for supporting the axle body in the installation position whereby the level difference between the loaded and the unloaded vehicle body can be reduced and consequently the dependency of the steer behavior of the rear axle on the loading state of the vehicle can be reduced.

Furthermore, if the rear axle includes an air spring unit for supporting the vehicle body vertically in the installation position a particularly advantageous vibration uncoupling and, as a result, high comfort can be achieved. Furthermore, an air spring unit is adjustable in a simple manner so that the body can be maintained at a particular level independently of the loading state of the vehicle. Beside an air spring unit other adjustable spring units as known to the person skilled in the art may be used.

If, in the installation position, with a horizontal level road surface, the air spring unit is arranged at least essentially, symmetrical relative to a vertical support force component generated by a weight force, in the longitudinal and/or in the transverse direction, a particularly advantageous vibration uncoupling of the rear axle from the body of a motor vehicle can be achieved, Specifically moments and forces caused by a non-symmetrical arrangement in support locations of the longitudinal force support structure and vibrations and noises generated thereby can be avoided to a large extent.

Further advantages of the invention will become apparent from the following description of a particular embodiment thereof described below on the basis of the accompanying drawings.

### BRIEF DESCRIPTION OF THE DRAWINGS

FIG. 1 show a rear vehicle axle according to the invention in a perspective view,

FIG. 2 is a schematic top view of the rear axle during straightforward travel of the vehicle,

FIG. 3 is a schematic top view of the rear axle of a vehicle while negotiating a curve,

FIG. 4 shows a bearing unit for supporting a longitudinal rear axle support arm including a spring structure,

FIG. 5 is a cross-sectional view taken along line V-V of FIG. 4, and

FIG. 6 is a side view of the rear axle mounted on the body of a motor vehicle.

### DESCRIPTION OF A PREFERRED EMBODIMENT

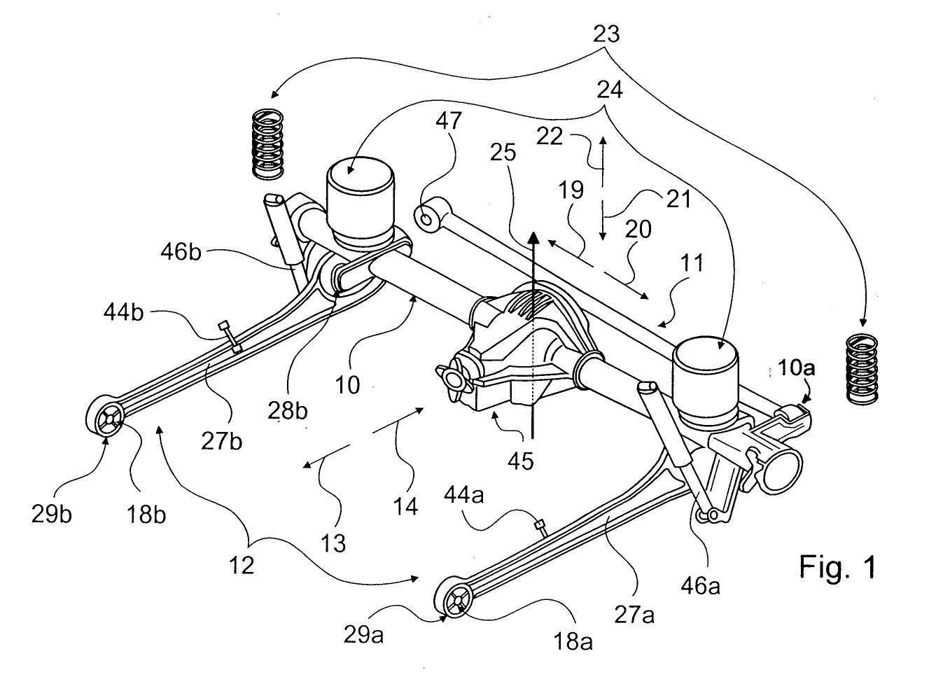

FIG. 1 shows, in a perspective view, a driven rear axle of a motor vehicle with a rigid axle body 10 provided, in the center area thereof, with a differential transmission 45. The rear axle includes a transverse force support unit 11 for accomodating side forces Fₛₐ, Fₛᵢ, which is arranged in parallel spaced relationship at a distance 26 from the axle body 10 (FIGS. 1, 2, 3). The transverse force support unit 11 includes a rod which extends transverse to the longitudinal direction 13 of the vehicle and which, with a first end thereof, is connected to the axle 10 (at 10a) pivotably about an axis extending in the longitudinal vehicle direction 13 and, at its second end, is provided with a bearing sleeve receiving a bearing structure 47 by way of which the rod 11 can be connected to the body 43 of a van designed for such a rear axle.

Furthermore, the rear axle includes a longitudinal force support arrangement 12 formed by a longitudinal guide arm structure for accommodating longitudinal forces. The longitudinal force support arrangement 12 comprises two guide arms 27a, 27b oriented in the longitudinal direction 13, which are coupled at a first end to the axle body 10 via four rubber bearings 28a, 28b. The rubber bearings 28a, 28b reduce a torsion moment applied to the axle body 10 by the two guide arms 27a, 28b and have in the longitudinal direction 13, 14 a spring constant of 3000 N/mm; basically they could have a spring constant of 3000 N/mm to 9000 N/mm. At their opposite second end, the longitudinal guide arms 27a, 27b are provided with bearing sleeves for receiving bearing units 29a, 29b for mounting the guide arms to the body of the van.

The longitudinal guide arms 27a, 27b of the longitudinal force support arrangement 12 are movable for achieving the side force steering upon occurrence of side forces Fₛₐ, Fₛᵢ. To this end, the bearing units 29a, 29b of the longitudinal force support arrangement 12 include spring units 18a, 18b for movably supporting the longitudinal guide arms 27a, 27b in the longitudinal direction.

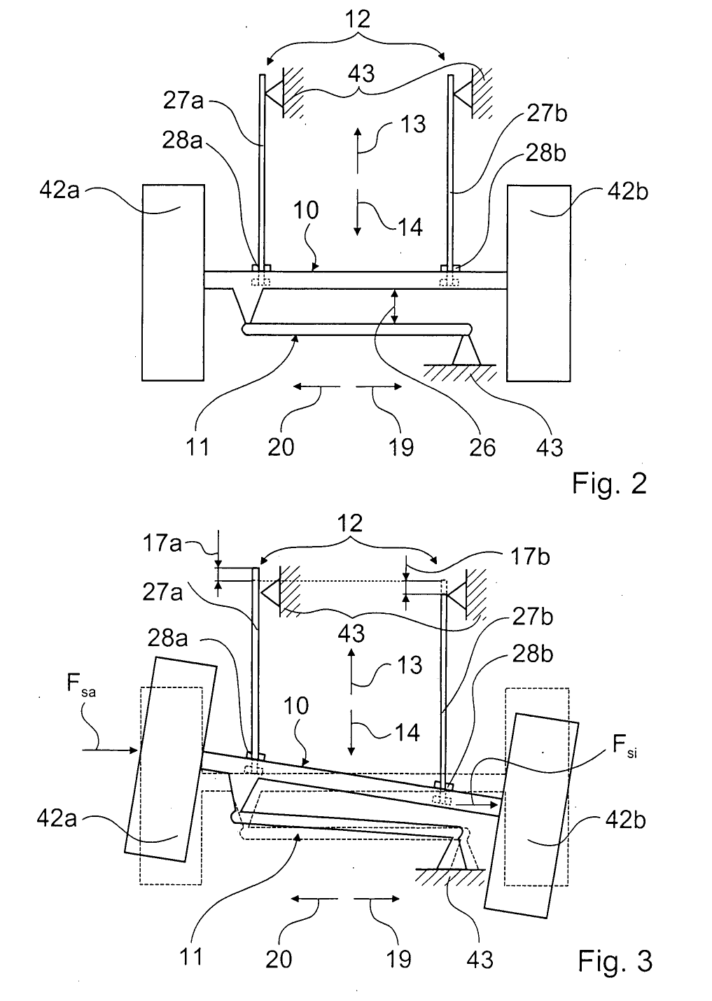

The longitudinal guide arms 27a, 27b of the longitudinal force support arrangement 12 are supported on the vehicle body 43 so as to be movably in the longitudinal direction 13, 14, each by the spring units 18a, 18b of the bearing units 29a, 29b over a distance 17a, 17b of ±3 mm starting out from an equilibrium or rest position (FIG. 2-5).

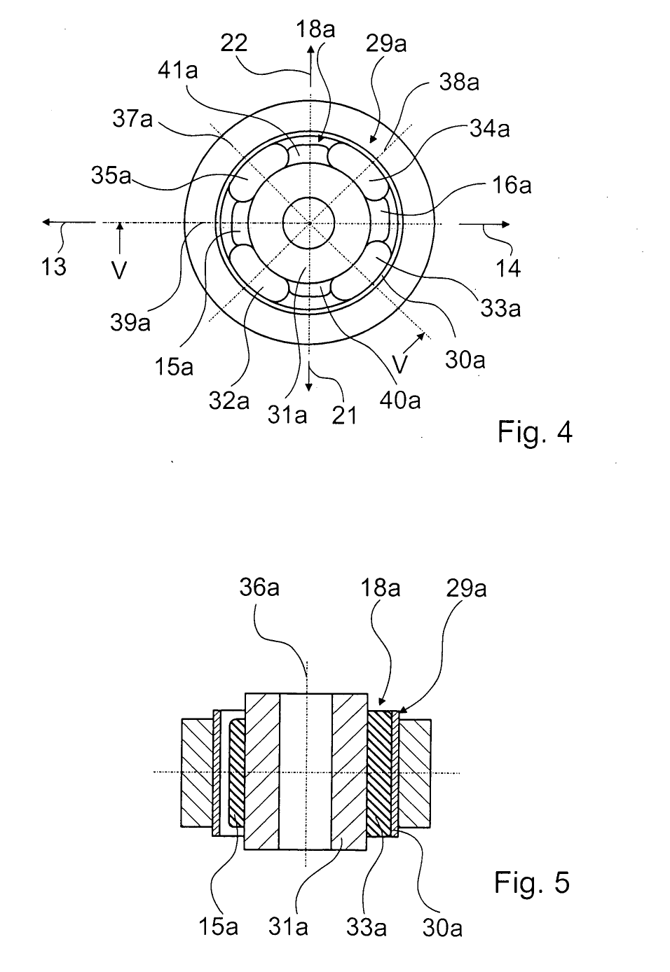

Below, the bearing unit 29a will be described, which is the same as the bearing unit 19b. The spring unit 18a is arranged radially between an outer bearing ring 30a and an inner bearing ring 31a of the bearing unit 19a. The spring unit 18a comprises four plastic spring elements 32a, 33a, 34a, 35a, which are each in contact at their inner circumference with the inner bearing ring 31a and at their outer circumferences with the outer bearing ring 30a. Two of the plastic spring elements 32a, 33a, 34a, 35a are arranged with respect to the bearing axis 36a of the bearing unit 29a opposite one another and, along the axes of symmetry 37a and 38a which extend normal with respect to each other and with respect to the bearing axis 36a, and which extend each at an angle of 45° with respect to a horizontal axis of symmetry 39a extending parallel to the longitudinal direction 13 (FIGS. 4, 5).

The spring unit 18a includes, in radial direction, stops 15a, 16a, 40a, 41a providing for an impedance jump, that is, a sudden impedance increase. The stops 15a 16a, 40a, 41a, which are also formed by spring elements are arranged circumferentially between the plastic spring elements 32a, 33a, 34a, 35a, are in contact at their inner ends with the inner bearing ring 31a and, because of their smaller radial extent with respect to the plastic spring elements 32a, 33a, 34a, 35a, are disposed at a radial distance from the outer bearing ring 30a.

Up to the engagement of the stops 15a, 16a, with the inner surface of the outer bearing ring 30a, that is, over a distance 17a, 17b of ±3 mm, the spring unit 18a has a spring constant of about 90 N/mm. In the vertical direction 21, 22, the spring unit 18a has up to the engagement of the stops 40a, 41a in the inner circumference of outer bearing ring 30a a spring constant of about 1600 N/mm and in the direction of the bearing axis 36a the spring unit 18a has a spring constant of about 150 N/mm. When the stops 15a, 16a, 40a, or 41a, abut the inner circumference of the outer bearing ring 30a, the spring constant of the spring unit 18a in the direction of the respective abutting stop 15a, 16a, 40a, or 41a jumps to about 6300 N/mm, and 10,000 N/mm would be possible.

The bearing unit 47 which is formed by a slotted sleeve also includes a spring unit which is not shown in detail but which has a much larger spring constant in the transverse direction 19, 20 than the spring unit 18a of the longitudinal force support arrangement 12 has in the longitudinal direction 13, 14. This spring unit has a spring constant in the transverse direction of about 100,000 N/mm.

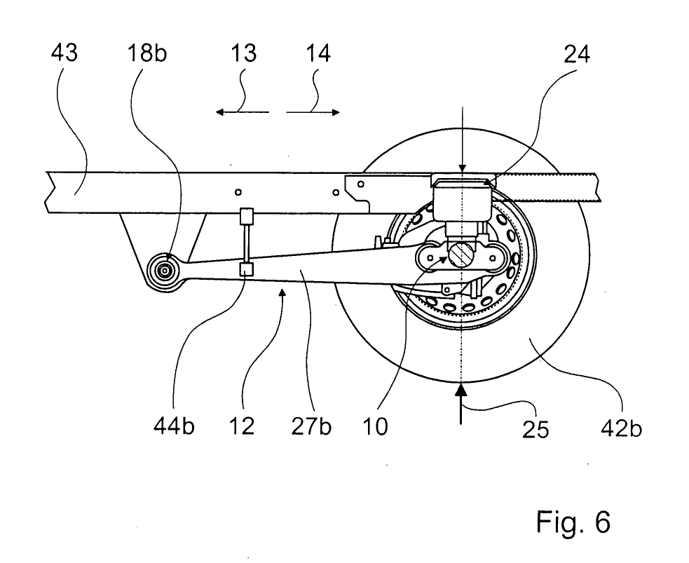

When installed the axle body 10 can be supported in vertical direction 22 by a spring unit 23 formed by two compression coil springs with a progressive characteristic spring line or it may, alternatively, be supported in the vertical direction 22 by an air spring arrangement 24 formed by two air spring bellows. The air spring arrangement 24 is arranged in the installed position and with a horizontal, planar road surface, essentially symmetrical with respect to a vertical support component 25 of the axle body 10 in the longitudinal direction 13, 14 and in the transverse direction 19, 20. The resulting vertical support component 25 is a combination of two vertical support forces provided by two vehicle wheels 42a, 42b, and extends in the transverse direction 19, 20 in the middle of the axle body 10 in vertical direction 22 and intersects a horizontal center axis of the axle body 10 (FIGS. 1 and 6) at an angle of 90°. The two spring bellows of the spring unit 24 are supported at their ends adjacent the axle body 10 directly on the axle body 10 so that the spring axes of the spring bellows intersect the horizontal center axis of the axle body 10 and are disposed at an equal distances from the vertical support component 25 extending between the two air bellows. It would also be possible that the air spring bellows have spring axes which are arranged in spaced relationship from the horizontal center axis of the axle body 10 particularly if moments can be compensated for or equalized by such a displaced arrangement of the bellows.

Because of the space-saving design of coil compression springs as well as air spring bellows, shock absorbers 56a, 46b can be arranged at a relatively large distance from each other in the transverse direction 19, 20 which is advantageous with respect to the driving dynamics.

By means of the sensors 44a, 44b arranged between the longitudinal guide arms 27a, 27b and the vehicle body 43 the loading state can be determined and, using a control unit which is not shown in the figures, the road clearance of the van can be adjusted via the air spring unit 24 to a constant level.

During travel along a bend, side forces Fₛₐ Fₛᵢ are accommodated between the vehicle axle and vehicle body 43 by way of the transverse force support unit 11. FIG. 3, for example, shows the rear axle in a right hand curve. Because the transverse force support unit 11 is spaced from the axle body 10, a moment is generated which tilts the axle body 10 about a vertical axis in a toe-in or under-steer sense. The longitudinal guide arm 27a is displaced in the bearing unit 29a in the longitudinal direction 13 up to a maximum displacement 17a of 3 mm and the longitudinal guide arm 27b is displaced in the bearing unit 29b in the longitudinal direction 14 up to a maximum displacement 17b of also 3 mm. Particularly the length of the longitudinal guide arms 27a, 27b and their relevant parameters are selected and tuned in such a way that a tilt steering component is always zero.

In a left hand turn, the longitudinal support arms 27a, 27b are displaced in the opposite direction. During emergency braking, both longitudinal support arms 27a, 27b are displaced in the longitudinal direction 14 by 3 mm until the stop 15a of the bearing unit 29a and a corresponding stop of the bearing unit 29b abut the respective bearing rings.

1. A rear vehicle axle comprising an axle body (10) for supporting a vehicle body (43), a transverse force transmission unit (11) for transferring vehicle body side forces to the axle body (10) and a longitudinal force support arrangement (12) for transferring longitudinal forces between the vehicle body (43) and the axle body (10), the longitudinal force support arrangement (12) having means which are movable so as to be displaced when the axle body (10) is subjected to side forces (Fₛₐ, Fₛᵢ) while the vehicle is negotiating a curve, for providing side force steering motion for the vehicle axle.

2. A rear vehicle axle according to claim 1, wherein the longitudinal force support arrangement (12) comprises at least one spring unit (18a, 18b) for supporting the means which are displaceable.

3. A rear vehicle axle according to claim 2, wherein the spring unit (18a, 18b) includes in the longitudinal direction (13, 14) at least one impedance jump.

4. A rear vehicle axle according to claim 3, wherein the spring unit (18a, 18b) includes at least one stop member (15, 16, 40, 41) for providing the impedance jump.

5. A rear vehicle axle according to claim 4, wherein the stop member (15, 16, 40, 41) is a spring number.

6. A rear vehicle axle according to claim 2, wherein the spring number has, effective in the longitudinal direction, a spring constant of between 750 N/mm.

7. A rear vehicle axle according to claim 1, wherein the displaceable means of the longitudinal force support arrangement (12) is displaceable in the longitudinal direction (13, 14) over a distance (17a, 17b) of at least 1 mm.

8. A rear vehicle axle according to claim 7, wherein a tilt-steer-part provided by the displaceable means is less than 0.3° wheel tilt angle.

9. A rear vehicle axle according to claim 2, wherein the transverse force support arrangement (11) comprises a bearing structure (47) for supporting the axle and the vehicle body in the transverse direction (19, 20), which has in the transverse direction (19, 20) a spring-constant which is larger than that of the spring unit (18a, 18b) of the longitudinal force support arrangement (12) in the longitudinal direction (13, 14).

10. A rear vehicle axle according to claim 1, wherein the spring unit (23) has a progressive spring characteristic line in a vertical direction for supporting the vehicle body (43).

11. A rear vehicle axle according to claim 1, wherein an air spring unit (24) is provided for supporting the vehicle body (43) on the axle body (10).

12. A rear vehicle axle according to claim 11, wherein the air spring unit (24) includes bellows which are equally spaced in a transverse direction from a vertical central support force component (25) of the axle body (11) when the vehicle is disposed on a planar surface.

13. A motor vehicle with a rear axle as defined in claim 1.
